(19) United States
(12) Patent Application Publication
(10) Pub. No.: US 2001/0039530 A1
(43) Pub. Date: Nov. 8, 2001

(54) Trading simulation

(76) Inventor: Vincent P. Annunziata, Greenwich, CT (US)

Correspondence Address: ST. ONGE STEWARD JOHNSTON & REENS, LLC, 986 BEDFORD STREET, STAMFORD, CT, 06905-5619, US

(21) Appl. No.: 09/764,558

(22) Filed: Jan. 18, 2001

Related U.S. Application Data
(60) Provisional application No. 60/176,503, filed on Jan. 18, 2000.

(51) Int. Cl. G06F 17/60

(52) U.S. Cl. 705/37

(57) ABSTRACT

A system for providing a game that simulates the trading of commodities comprising a computer accessible by a plurality of players over a computer network and a database accessible by the computer containing a plurality of player files associated with a plurality of players of the system wherein each of the plurality of player files contains a player portfolio associated with a specific player including commodities and units thereof and a money value. The plurality of player files further contains a player score determined by said computer based on the player portfolio. The system further includes a database accessible by the computer containing a plurality of indications submitted by players of the system to the computer over the computer network. Each of the plurality of indications relates to a bid or offer for a specified number of units of a specified commodity at a specified unit price. A player submits an indication selected from the plurality of indications to the computer over the computer network. Software executing on the computer receives the selected indication from the player, retrieves a player portfolio from the player database corresponding to the player, updates the commodities and units thereof in the retrieved player portfolio to reflect the selected indication, updates the money value in the retrieved player portfolio to reflect the selected indication, and removes the selected indication from the indication database.

### PRIOR APPLICATION

This application claims benefit of U.S. Provisional Patent Application Ser. No. 60/176,503 filed Jan. 18, 2000.

### FIELD OF THE INVENTION

The invention relates to a system for simulating the trading of commodities and the like over the Internet.

### BACKGROUND OF THE INVENTION

The commodities market is a constantly evolving market covering a wide variety of tradeable goods. There are three basic segments of the commodities market: agricultural, natural resources, and financial instruments. The agricultural segment is a broad segment covering everything from grains, such as corn and wheat, to oils and meal, such as soybeans and sunflower seed oil, to livestock such as live cattle and pork bellies. The agricultural segment also includes forest products, such as lumber and plywood, textiles such as cotton, and foodstuffs such as coffee and sugar. The natural resources segment covers metals and petroleum, such as gold, copper, crude oil and natural gas. The financial instruments segment is another broad market covering everything from interest bearing assets, such as government treasury bills to municipal bonds, to foreign currencies, such as the yen and Euro, to futures on most major indexes, such as the S&P 500 and New York Stock Exchange Composite. For each of these commodities there are different contract months, grades, amounts, and types available for trading and the available commodities and contracts expands on nearly a daily basis.

While many people find investing in commodities to be challenging and fun due to great breadth of available commodities and the many variables involved with each, many lack the time, means or ability to effectively trade in the commodities market. Also, many do not desire to risk their money in the often volatile market. With the recent rise in popularity of computer games and interactive gaming via the Internet and other communications methods, many of those that would possibly enjoy the challenge of trading commodities but cannot due to various reasons seek a game or simulation which would allow them to attempt to trade in the commodities market in a game setting without risking any real money.

Therefore, what is desired is a computer game that simulates the trading of commodities. Such a game that can be played interactively with other players over the Internet is also desired.

### SUMMARY OF THE INVENTION

Accordingly, it is an object of the invention to provide trading game that enables players to simulate commodities trading.

Another object of the invention is to provide a trading game of the above nature that is playable by multiple players.

A further object of the invention is to provide a trading game of the above nature that is playable over the Internet.

These and other objects of the present invention are accomplished by the provision of a system for providing a game that simulates the trading of commodities. The system comprising a computer accessible by a plurality of players over a computer network, a database accessible by the computer containing a plurality of player files associated with a plurality of players of the system wherein each of the plurality of player files contains a player portfolio associated with a specific player including commodities and units thereof and a money value. The plurality of player files further contains a player score determined by said computer based on the player portfolio. The system further includes a database accessible by the computer containing a plurality of indications submitted by players of the system to the computer over the computer network. Each of the plurality of indications relates to a bid or offer for a specified number of units of a specified commodity at a specified unit price. A player submits an indication selected from the plurality of indications to the computer over the computer network. Software executing on the computer receives the selected indication from the player, retrieves a player portfolio from the player database corresponding to the player, updates the commodities and units thereof in the retrieved player portfolio to reflect the selected indication, updates the money value in the retrieved player portfolio to reflect the selected indication, and removes the selected indication from the indication database.

The system may further include a database containing game rules for controlling the game flow and processing of indications and software executing on the computer determining player scores, ending the game and determining winners. Software for receiving indication submissions from players may also be included. The system may also generate a presentation of the plurality of indications for perusal and selection by players. Preferably, the computer network comprises the Internet and the system further comprises software executing on the computer for operating and maintaining a website for facilitating communication between the computer and the player.

The invention and its particular features and advantages will become more apparent from the following detailed description considered with reference to the accompanying drawings.

### BRIEF DESCRIPTION OF THE DRAWINGS

FIG. 1 is a schematic of a system for providing a game that simulates the trading of commodities between a plurality of players in accordance with the present invention.

FIG. 2 is a schematic of the authentication process of the system depicted in FIG. 1.

FIG. 3 is a schematic of the indication presentation process of the system depicted in FIG. 1.

FIG. 4 is a schematic of the indication submission process of the system depicted in FIG. 1.

FIG. 5 is a schematic of the selection and processing of indications process of the system depicted in FIG. 1.

FIG. 6 is a schematic of game control and scoring process of the system depicted in FIG. 1.

### DETAILED DESCRIPTION OF THE DRAWINGS

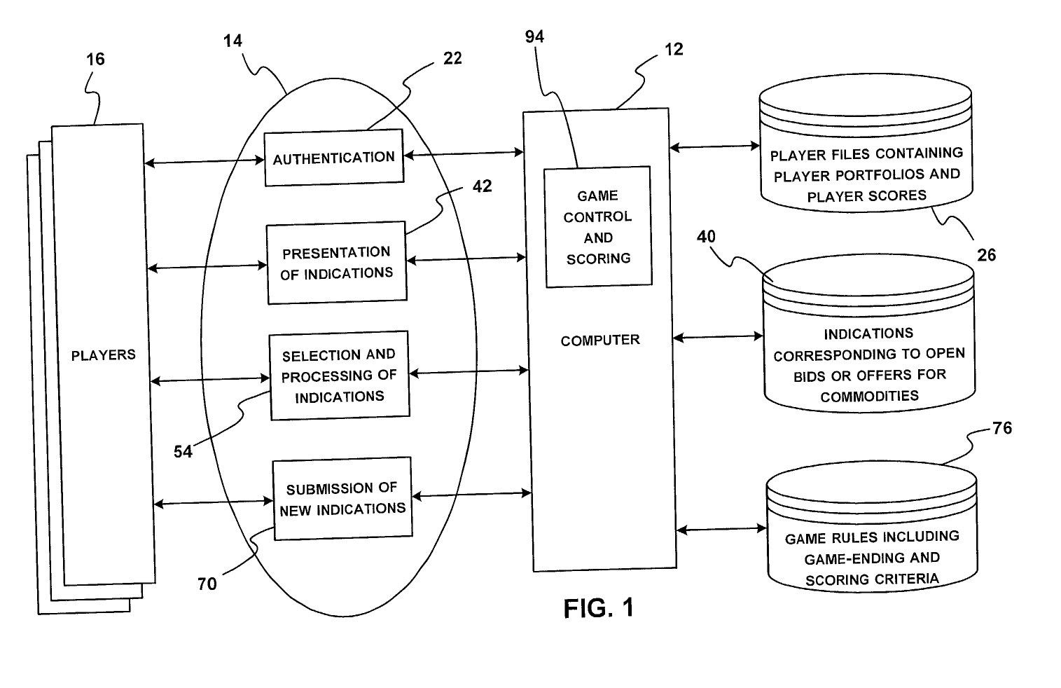

FIG. 1 depicts a system 10 for providing a game that simulates the trading of commodities between a plurality of players in accordance with the invention. The system 10 includes a computer 12 accessible over a computer network 14 by the players 16 of the system 10. The computer 12 may be any type of computing device capable of performing the functions described herein. For example, the computer 12 may be a personal computer, minicomputer, mainframe, supercomputer, web server, or any combination thereof. The computer network 14 may take any suitable form that permits communication between the players 16 and the computer 12, such as a local area network or wide area network. Preferably, the computer network 14 comprises the Internet and the computer includes an appropriate connection between the computer 12 and the Internet and software executing on the computer 12 for operating and maintaining an interactive website for facilitating communication between the computer 12 and players 16.

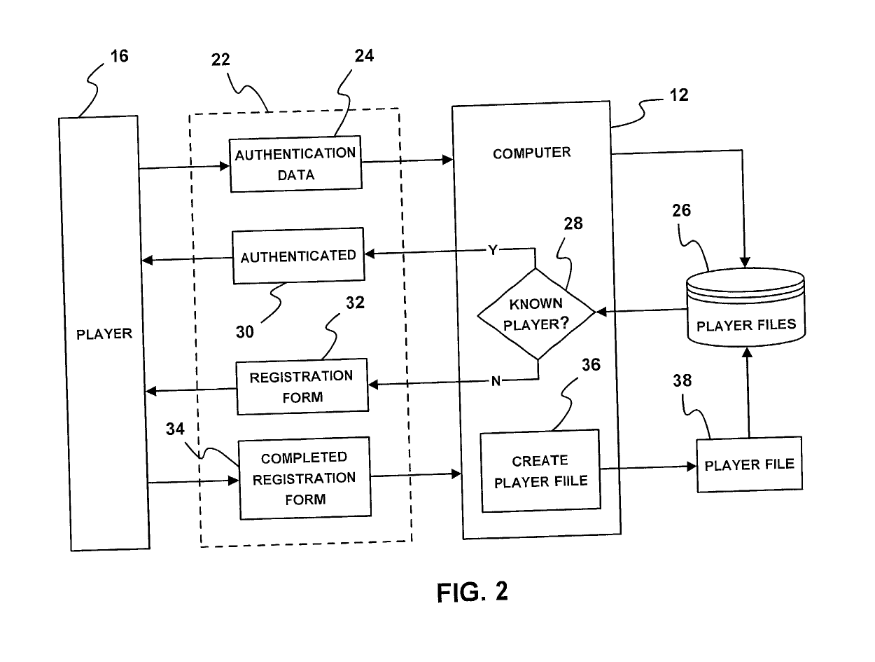

A player 16 of the system 10 must first be authenticated 22 before he can enter and utilize the system 10. The authentication process 22, shown in FIG. 2, generally includes the submission of authentication data 24 associated with the player 16 that permits the computer 12 to recognize the player 16, such as a username and password. Software executing on the computer 12 may transmit a prompt to the player 16 over the computer network 14 requesting the player's authentication data. The player 16 then submits 24 his authentication data to the computer 12 over the computer network 14. Upon receipt, software executing on the computer 12 accesses a database 26 containing a plurality of player files to verify 28 the submitted authentication data 24. The player file acts as a depository for all information related to the player. Once verified, the player 16 has been authenticated 30 and can proceed to use the system 10. Alternately, the system 10 may include cookie technology that permits the computer 12 to immediately identify and recognize the player 16 once the player accesses the system 10 or the system 10 may include software executing on the computer 12 that recognizes the player based on the player's Internet Protocol (IP) address. These alternatives would allow the player 16 to be immediately recognized without having to actively submit any authentication data.

If the player 16 does not have any authentication data 24, he may request to register with the system 10. In such a case, software executing on the computer 12 transmits a registration form 32 to the player 16. The registration form 32 may also be transmitted to a prospective player via other means such as e-mail or postal service. Preferably, though, the registration form 32 is electronic and is received and completed 34 by the player 16 and returned electronically via a website to expedite and simplify the process. The registration form 32 may request any information deemed to be necessary by the administrators of the system 10 to permit the player 16 to participate in the game and any preferences the player may have regarding various options described herein. Once the registration form has been submitted 34 and approved, the player 16 is assigned authentication data 24, such as a username and password, and a player file 38 related to the player 16. The player file contains the authentication data 24 and any other information provided by the player in the registration form and is created 36 and stored in the player database 26. It is to be understood that authentication data 24 such as player names and passwords can be chosen by the player 16, such as within the registration form 32 as opposed to being assigned by the computer 16 or system administrators.

Once an authenticated player 16 accesses the system 10, software executing on the computer 12 accesses a database 40 containing a plurality of open bids and offers currently available for trading that have been previously submitted by other players 16 of the system 10. Such open offers and bids are generally referred to as indications of interest, or indications for short. Each indication contains relevant information pertaining to the bid or offer such as the type of commodity involved, the number of units of commodity available, the unit price of the commodity, and/or the name of the player that submitted the indication. The software retrieves the indications from the database 40 and presents 42 them to the player 16 over the computer network 14. Generally, the indications are presented to the player 16 as a list or table that permits the player 16 to select any specific indication.

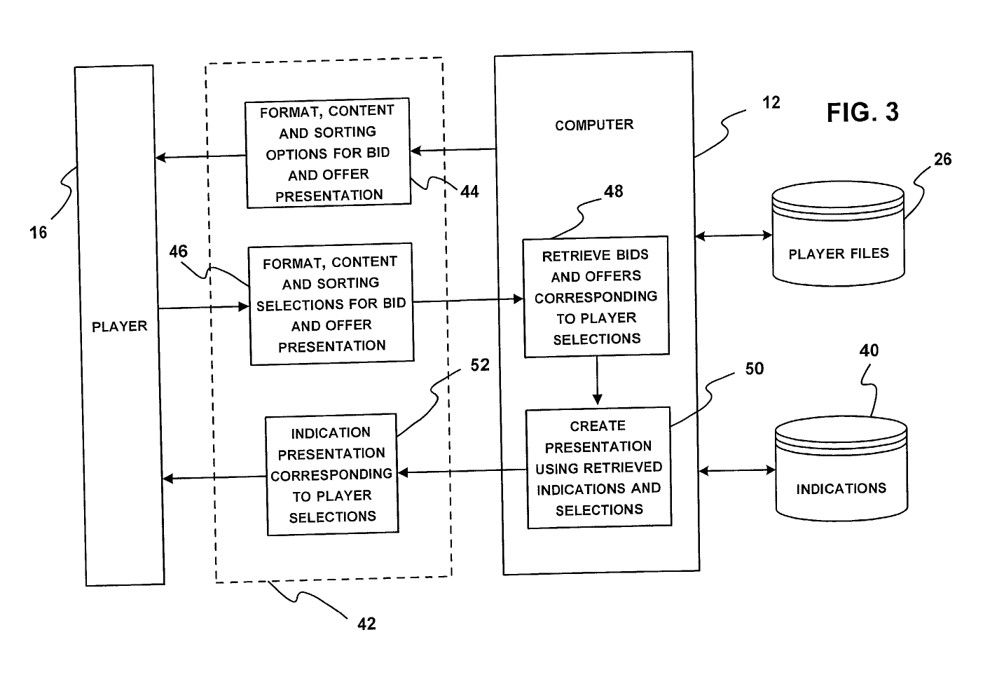

Preferably, the presentation 42 of the indications is completely sortable and interactive to permit the player 16 to quickly and easily access any desired indications that are available, as shown in FIG. 3. Software executing on the computer 12 may transmit a plurality of format, content, and/or sorting options 44 to the player 16 over the computer network 14. Such format options may include the format in which the bids and offers are presented to the player 16, such as in tabular or graphical format. Content options may allow a player 16 to retrieve indications for specific bids or offers having certain parameters, such as commodity type, bid versus offer, or other discernible difference ascertainable from any information submitted with the indication. For example, the player 16 may seek only open offers on crude Brent or firm bids from another specific player. The software may also transmit a plurality of sorting options to the player 16 over the computer network 14. Such sorting options could include options to sort by date posted, highest/lowest price, quantity available, etc.

It is to be understood that the format, content, and sorting options of the presentation 42 of the indications are closely interrelated and can be presented to the player 16 simultaneously. Upon receipt of the customer selections 46, if any, software executing on the computer 12 queries the indication database 40 to retrieve 48 any indications corresponding to the player's selections 46. The software then creates 50 a presentation of the retrieved indications based on the player's selections 46. The created presentation is then transmitted and displayed 52 to the player 16 over the computer network 14. Preferably, during the registration process or otherwise, the player submits the player's preferred format, content, and sorting options to the system 10 and the preferred options are stored in the player's player file. As such, the player 16 may be presented with a display corresponding to their preferred options whenever the player 16 accesses the game. For example, the player 16 may desire to primarily trade in three types of commodities and only desire to see the five indications in each commodity having the lowest offer price. The player 16 would still be able to modify the presentation upon accessing the system 10 and could modify the preferred options from time to time as needed or desired.

By way of example, the player 16 may be presented with a menu permitting the player 16 to select which commodities for which he would like to view indications and in what order the display would be organized. For example, the player 16 may wish to be presented with a table displaying the currently open offers on crude Brent arranged according to number of barrels available. Additionally, the player 16 may search for a particular offer matching specific parameters, such as bids on Brent for a specified price, submitted by the player 16 to the computer 12 over the computer network 14.

Preferably, the system 10 further includes software executing on the computer 12 for refreshing and updating the player's presentation 52 of indications to reflect new bids and offers as other players of the game submit them. Therefore, the player 16 can be apprised on a real-time basis of the current bids and offers available for trading within the system 10. Regardless of the format or style of the presentation 52 of indications chosen by the player 16, it is important that the player 16 be presented with sufficient information to make a determination as to whether or not the player 16 would like to select the bid or offer further. As such, initial displays 52 may only present a limited summary of the bid or offer in order to conserve space and facilitate quicker perusal of larger number of bids and offers. The player 16 may then request more detailed information regarding specific bids and offers, if desired.

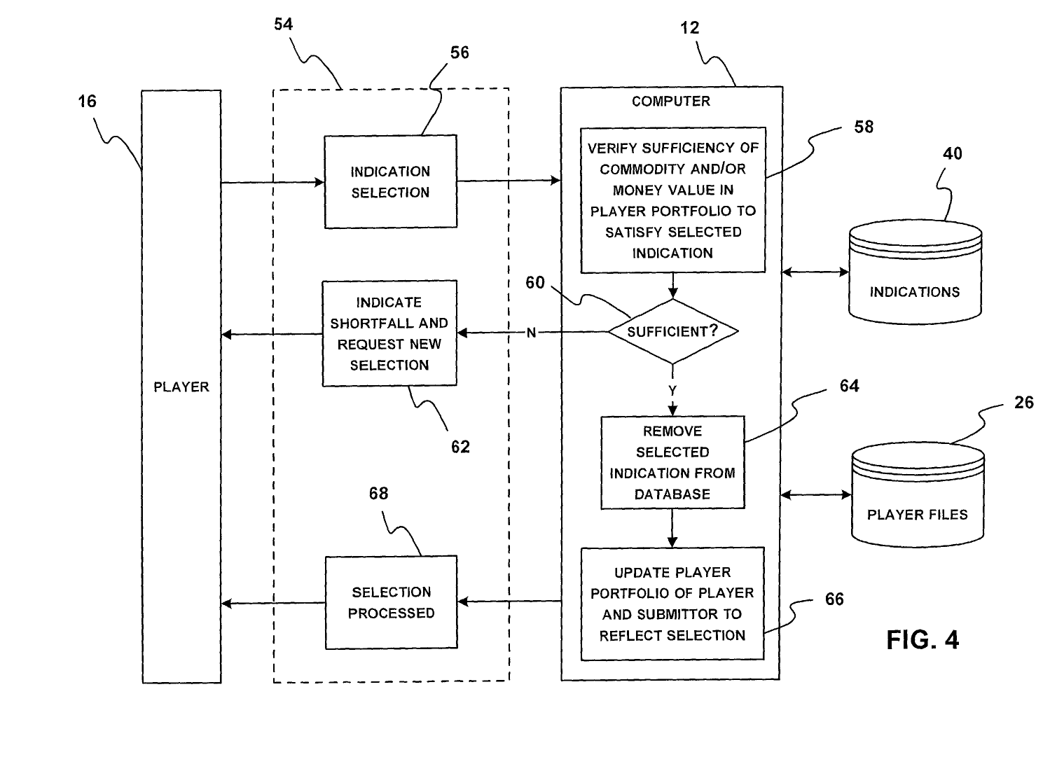

Once the player 16 finds an indication that he desires to accept, the player 16 may select the indication from the presentation 52 and submit 56 the selection to the computer 12 over the computer network 14 for processing and scoring 54, as shown in FIG. 4. Software executing on the computer 12 would receive the indication selection 56 and retrieve the player portfolios of the player selecting the indication and the submitter of the indication. The software updates 66 the player portfolios of both the player who selected the indication and the player or submitted the selected indication to reflect the selected indication 56 and removes 64 the selected indication 56 from the indication database 40. Once a selected indication is successfully processed, software executing on the computer 12 may transmit a confirmation 68 that the indication was accepted to the player 16 and the submitter of the selected indication over the computer network 14.

As an example of the selection process, presume a player 16 has a player portfolio containing no barrels of Brent and one million dollars. If that player selects an indication offering to sell ten thousand barrels of Brent at twenty dollars a barrel, the software would process the selected indication by updating the player's player portfolio to indicate that he now has ten thousand barrels of Brent and reduce the player's money value two hundred thousand dollars to eight hundred thousand dollars. Likewise, the player portfolio of the submitter of the indication selected would be updated to reduce the number of barrels of Brent by ten thousand and increase his money value two hundred thousand dollars.

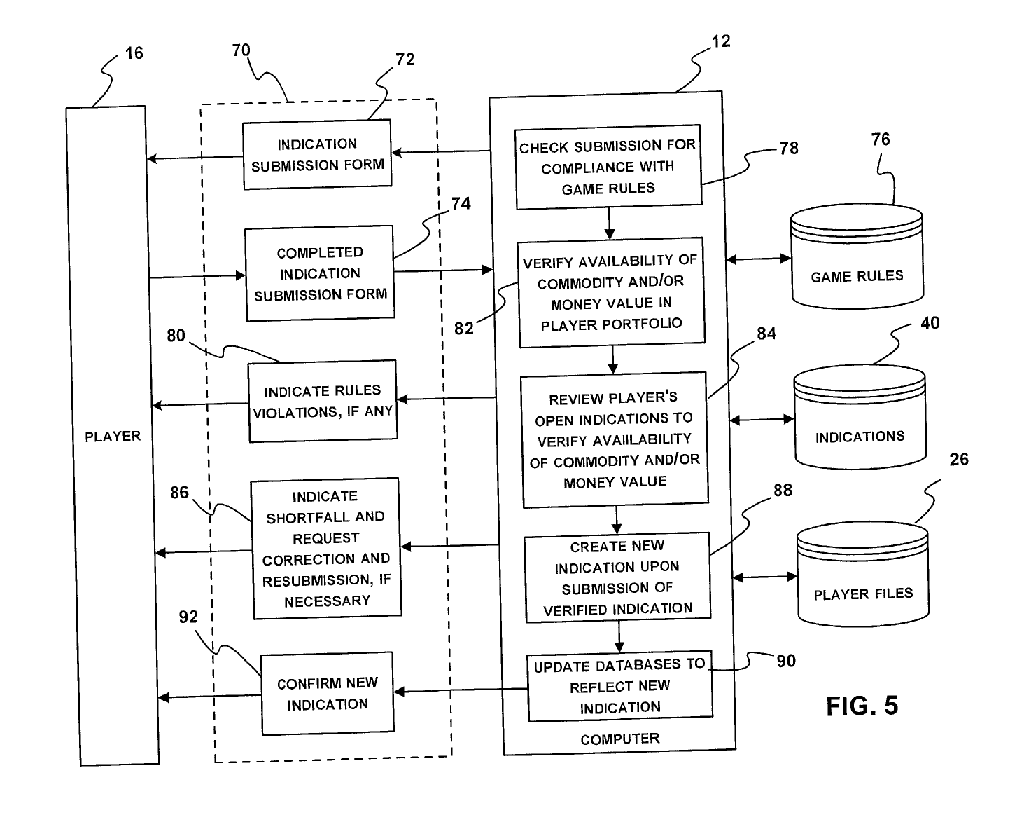

As shown in FIG. 5, in order to submit 70 a bid or offer to the system 10, the player 16 must complete and submit an indication submission form 72. Software executing on the computer may transmit the submission form 72 to the player 16 over the computer network 14. Alternately, the submission form 56 may be incorporated into the indication presentation 52 to permit the player 16 to quickly view the existing market depth and submit a bid or offer. The submission form 72 generally requests the commodity type, number of units, and unit price. Upon receipt of a completed submission form 74, software executing on the computer 12 queries a database 76 containing the rules of the game to verify 78 compliance of the proposed indication therewith. The game rules consist of the rules and guidelines for playing on the trading simulation. In the context of new indication submissions, the rules may contain limits on the amount or type of units in which specific commodities may be offered, pre-defined lot sizes for various commodities, or limits on the total open position a player may maintain at any given time overall or for specific commodities. It is to be understood that the specific rules of the game are at the discretion of the designer. The software may indicate 80 to the player 12 that there has been rules violations, if any are found to exist.

Once a proper indication has been submitted, software executing on the computer 12 creates 88 a new indication based on the information provided by the player 16 in the completed indication submission form 74 and stores 84 the new indication in the indication database 40. Preferably, the software also updates 90 the player's associated player file in the player database 26 to reflect the submitted indication. This readily permits the player 16 to access and review all the indications he has submitted. Once stored in the indication database 40, the new indication may be accessed and presented to all current and subsequent players of the system 10 for their perusal and action. The software may also transmit a confirmation of the new indication 92 to the player 16 over the computer network 14. Additionally, software executing on the computer may permit the players to withdraw or cancel a submitted indication if such indication has not been selected or processed as of the time of withdrawal.

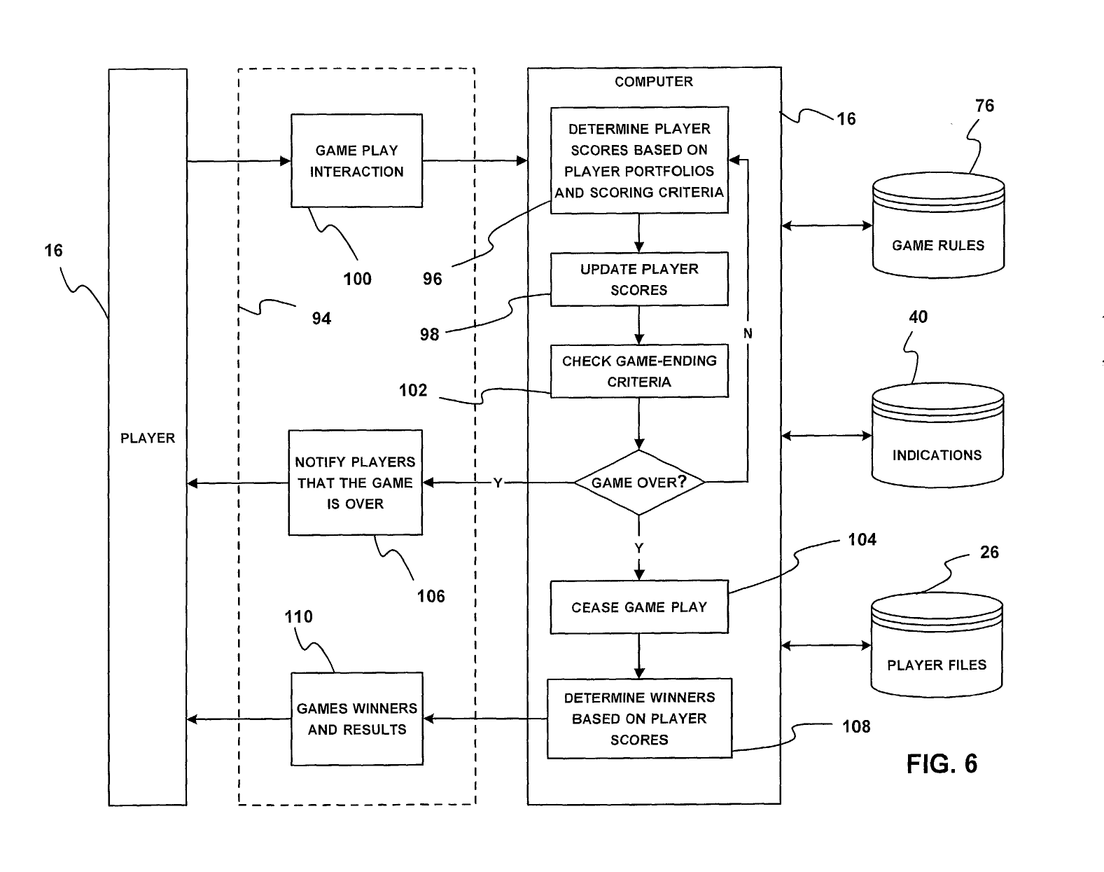

Software executing on the computer 12 controls 94 of the game flow and determines scoring and results, as shown in FIG. 6. The player files further contain player scores based on the current value of the players'player portfolios according to predetermined scoring criteria indicated in the game rules. Generally, the player score is determined 96 to be the sum of the player's money amount and the current market value of any commodities in the player portfolio. The current market value of the commodities is determined using the most recent unit price at which a particular commodity was processed. It is to be understood that many different types and methods of scoring may be incorporated into the game. Preferably, the software continually updates 98 player scores of the players following each indication that is processed 100 so that a real time score may be used by the system 10 and/or viewed by the players 16. However, scoring may be done at periodic intervals or merely at the end of the game.

To determine the end of the game, software executing on the computer 12 queries the game rules database 76 to determine 102 the game-ending criteria. The game ending criteria may be a preset time period or a preset portfolio value. For example, the game may end at a certain time on a specified date or when a player reaches a particular player score. In the instance of where the game is time limited, software executing on the computer 12 merely ceases 104 to process further indication selections and submissions and proceeds to the scoring and results. Where a predetermined score is the criteria for ending the game, the software constantly reviews the player scores and ends 104 the game upon a player attaining that score. Regardless of the specific game-ending criteria, when the criteria are met, software executing on the computer 12 transmits 106 a notification to the players 16 overt the computer network 16 that the game has ended and ceases 104 further game play. The software then determines the players'final player scores and determines 108 winners based on the final player scores. Software executing on the computer 12 transmits 1 10 the results of the game to the players 16 over the computer network 14 and notifies 110 the winners of prizes, if any, to be awarded. Notification of winners may occur over the computer network 14 or other communications means such as phone, facsimile, e-mail, or regular post.

Preferably, all the players begin the game having an empty portfolio. Thus, the players must build their portfolio by buying and selling commodities. In such a game, there may or may not be trading limits on the various commodities within the game and such would be defined in the game rules. As such players may buy and sell commodities by submitting and selecting indications for the duration of the game. Preferably, upon satisfaction of the game ending criteria, software executing on the computer 12 would review each of the player portfolios to determine compliance with the game rules. In such an open-ended game, the game rules should include limitations on each players open positions to ensure a certain level of fairness. For example, a rule may require that no player have any open position for Brent in excess of fifty million barrels.

In another embodiment of the game, the player portfolio contains the player's currently available resources for use in the game. For example, the player portfolio may contain a listing of commodities and units thereof available to the player for trading and a money value corresponding to the amount of virtual money the player 16 may have available for accepting offers to sell from other players. In such a game, all the players would start the game with a predetermined amount of commodities and a predetermined money value in each of the player's player portfolios. As an example, a player portfolio may indicate that the player 16 has two million barrels of Brent and four million dollars available for completing bids and offers. Once the player portfolio is retrieved from the player's player file, software executing on the computer 12 would verify 58 that sufficient 60 resources are available to satisfy the selected indication 56. If not, the software transmits a notice to the player 16 indicating 58 the insufficiency. If sufficient resources are available, the software would update 66 the player portfolios of both the player who selected the indication and the player or submitted the selected indication to reflect the selected indication 56 and removes 64 the selected indication 56 from the indication database 40.

When submitting a proposed indication in such a game, software executing on the computer 12 would query the player's player portfolio to verify 82 the availability of sufficient units of the commodity being offered or sufficient available money value to cover a proposed bid. The game may or may not permit the player 16 to exceed the amount of money he may have available, depending on the game rules chosen by the designer. Preferably, software executing on the computer 12 further reviews 84 any other open indications the player 16 may have and makes a further determination on the availability of commodity units or money the player may have. For example, if a player has one-million barrels of Brent in his portfolio, the total combined number of units in all the player's open offers to sell Brent may not exceed one-million barrels. Likewise, if a player's money value is three million dollars, he may not have multiple open bids to buy that total more than three million dollars. If the software determines that the player has insufficient resources to satisfy a proposed indication, the software may indicate 86 the shortfall to the player 16 over the computer network 14.

The previous description and figures encompasses specific embodiments of the present invention. More specifically, the description and figures refer to the trading of commodities. While the description refers only to commodity trading, it is to be understood that the system is applicable to all types of trading of tangibles and/or intangibles, including, but not limited to, trading of products, things, services, stocks, securities, futures and bonds.

Although the invention has been described with reference to a particular arrangement of parts, features, and the like, these are not intended to exhaust all possible arrangements or features, and indeed many other modifications and variations will be ascertainable to those of skill in the art.

What is claimed is:

1. A system for providing a game that simulates the trading of commodities comprising:
a computer accessible by a plurality of players over a computer network;
a database accessible by said computer containing a plurality of player files associated with a plurality of players of the system wherein each of said plurality of player files contains a player portfolio associated with a specific player including commodities and units thereof and a money value; said plurality of player files further containing a player score determined by said computer based on said player portfolio;
a database accessible by said computer containing a plurality of indications submitted by players of the system to said computer over said computer network, wherein each of said plurality of indications relates to a bid or offer for a specified number of units of a specified commodity at a specified unit price;
an indication selected from said plurality of indications submitted by a player to said computer over said computer network; and,
software executing on said computer for receiving said selected indication from the player, retrieving a player portfolio from said player database corresponding to the player, updating said listing of commodities and units thereof in said retrieved player portfolio to reflect said selected indication, updating said money value in said retrieved player portfolio to reflect said selected indication, and removing the selected indication from said indication database.

2. The system of claim 1 further comprising:
a database containing game rules for controlling the game flow and processing of indications, said game rules including scoring criteria and game-ending criteria;
software executing on said computer for retrieving said scoring criteria from said game rules database, retrieving said player portfolio, determining a player score based on said player portfolio, storing said determined player score in said player database, retrieving said game-ending criteria from said game rules database, ceasing further game play when said game-ending criteria are met, retrieving player scores from each of said plurality of player files in said player database, and determining a winner based on said retrieved player scores.

3. The system of claim 2 further comprising software executing on said computer for retrieving the commodities and units thereof from the player file, determining a current value of the commodities based on a unit price at which each of the commodities was last processed, and determining said player score by adding said determined value to the money value in the player portfolio the sum.

4. The system of claim 2 wherein said game-ending criteria are met upon the expiration of a preset time period.

5. The system of claim 2 wherein said game-ending criteria are met upon one of said plurality of players attaining a predetermined player score.

6. The system of claim 2 wherein each of said players begins the game with an empty player portfolio and said game rules include predetermined limitations on a player's open position in any given commodity.

7. The system of claim 6 wherein said predetermined limitations on a player's open position in any given commodity are effective upon satisfaction of said game-ending criteria.

8. The system of claim 2 wherein each of said players begins the game with predetermined commodities and units thereof available for placing and accepting indications and a predetermined money value player portfolio available for placing and accepting indications.

9. The system of claim 1 further comprising;
a completed bid submission form containing a proposed bid to buy submitted by the player to said computer over said computer network; and,
software executing on said computer for transmitting an indication submission form to the player over said computer network, receiving said completed indication submission form submitted by the player, querying said retrieved player portfolio to verify sufficient money value to back said proposed bid, and creating a new indication based on said completed indication submission form, and storing said new indication in said indication database.

10. The system of claim 1 further comprising;
a completed offer submission form containing a proposed offer to sell submitted by the player to said computer over said computer network; and,
software executing on said computer for transmitting an indication submission form to the player over said computer network, receiving said completed indication submission form submitted by the player, querying said retrieved player portfolio to verify sufficient units of a commodity specified in said proposed offer to back said proposed offer, and creating a new indication based on said completed indication submission form, and storing said new indication in said indication database.

11. The system of claim 9 or 10, further comprising software executing on said computer for retrieving said game rules from said game rules database, determining whether said new indication violates said games rules, and notifying the player of any determined violations over said computer network.

12. The system of claim 1 further comprising:
a presentation of said plurality of indications transmitted from said computer to the player over said computer network, and, software executing on said computer for retrieving said plurality of indications from said indication database and transmitting said plurality of indications to the player over said computer network.

13. The system of claim 12 further comprising:
a formatting selection submitted to said computer by the player over said computer network; and,
software executing on said computer for transmitting a plurality of formatting options to the player over said computer network, receiving said formatting selection submitted by the player, and formatting said presentation according to said formatting selection prior to transmitting said presentation to the player.

14. The system of claim 12 further comprising:
a sorting selection submitted to said computer by the player over said computer network; and,
software executing on said computer for transmitting a plurality of sorting options to the player over said computer network, receiving said sorting selection submitted by the player, and sorting said presentation according to said submitted sorting selection prior to transmitting said presentation to the player.

15. The system of claim 12 further comprising:
a content selection submitted to said computer by the player over said computer network; and,
software executing on said computer for transmitting a plurality of content options to the player over said computer network, receiving said content selection submitted by the player, retrieving indications from said indications database corresponding to said submitted content selection, and transmitting said retrieved indications to the player over said computer network.

16. The system of claim 1 further comprising:
a request to register submitted by the player to said computer over said computer network;
software executing on said computer for transmitting a registration form to the player over said computer network link in response to said request.
a completed registration from submitted by the player to said computer over said computer network; and,
software executing on said computer for receiving said completed registration form, creating a player file based on said completed registration form, and storing said player file in said player database.

17. The system of claim 1 wherein said computer network comprises the Internet and said system further comprising software executing on said computer for operating and maintaining a website for facilitating communication between the computer and the player.
